(19) United States
(12) Patent Application Publication
(10) Pub. No.: US 2024/0037911 A1
(43) Pub. Date: Feb. 1, 2024

(54) IMAGE CLASSIFICATION METHOD, ELECTRONIC DEVICE, AND STORAGE MEDIUM

(71) Applicant: Beijing Baidu Netcom Science Technology Co., Ltd., Beijing (CN)

(72) Inventors: Ying Xin, Beijing (CN); Song Xue, Beijing (CN); Yuan Feng, Beijing (CN); Chao Li, Beijing (CN); Bin Zhang, Beijing (CN); Yunhao Wang, Beijing (CN); Shumin Han, Beijing (CN)

(73) Assignee: Beijing Baidu Netcom Science Technology Co., Ltd., Beijing (CN)

(21) Appl. No.: 18/109,522

(22) Filed: Feb. 14, 2023

(30) Foreign Application Priority Data
Jul. 29, 2022 (CN) 202210907494.6

(51) Int. Cl. G06V 10/764; G06V 10/44; G06V 10/80; G06V 10/82

(52) U.S. Cl. CPC G06V 10/764; G06V 10/44; G06V 10/806; G06V 10/82

(57) ABSTRACT

Provided is an image classification method, an electronic device and a storage medium, relating to a field of artificial intelligence technology, and specifically, to the technical fields of deep learning, image processing and computer vision, which may be applied to scenes such as image classification. The image classification method includes: extracting a first image feature of a target image by using a first network model, where the first network model includes a convolutional neural network module; extracting a second image feature of the target image by using a second network model, where the second network model includes a deep self-attention transformer network (Transformer) module; fusing the first image feature and the second image feature to obtain a target feature to be recognized; and classifying the target image based on the target feature to be recognized.

### CROSS-REFERENCE TO RELATED APPLICATIONS

The present application claims priority to Chinese Patent Application No. CN202210907494.6, filed with the China National Intellectual Property Administration on Jul. 29, 2022, the disclosure of which is hereby incorporated herein by reference in its entirety.

### TECHNICAL FIELD

The present disclosure relates to a field of artificial intelligence technology, and specifically, to the technical fields of deep learning, image processing and computer vision, which may be applied to scenes such as image classification.

### BACKGROUND

Image classification is an important research direction in the field of computer vision. With the development of deep learning, image classification is widely applied in the field of computer vision, such as face identification and intelligent video analysis in the security field, traffic scene recognition in the traffic field, content-based image retrieval and automatic album classification in the Internet field, and image recognition in the medical field. In the related art, the image classification methods are mostly implemented by a traditional machine learning method or a convolutional neural network method, and classification accuracy thereof is relatively low.

### SUMMARY

The present disclosure provides an image classification method and apparatus, a device and a storage medium.

According to a first aspect of the disclosure, provided is an image classification method, including: extracting a first image feature of a target image by using a first network model, where the first network model includes a convolutional neural network module; extracting a second image feature of the target image by using a second network model, where the second network model includes a deep self-attention transformer network (Transformer) module; fusing the first image feature and the second image feature to obtain a target feature to be recognized; and classifying the target image based on the target feature to be recognized.

According to a second aspect of the disclosure, provided is an image classification apparatus, including: a first obtaining module, configured to extract a first image feature of a target image by using a first network model, where the first network model includes a convolutional neural network module; a second obtaining module, configured to extract a second image feature of the target image by using a second network model, where the second network model includes a deep self-attention transformer network (Transformer) module; a feature fusion module, configured to fuse the first image feature and the second image feature to obtain a target feature to be recognized; and a classification module, configured to classify the target image based on the target feature to be recognized.

According to a third aspect of the disclosure, provided is provided is an electronic device, including: at least one processor; and a memory connected in communication with the at least one processor. The memory stores an instruction executable by the at least one processor, and the instruction, when executed by the at least one processor, enables the at least one processor to execute the method of the first aspect of the present disclosure.

According to a fourth aspect of the disclosure, provided is a non-transitory computer-readable storage medium storing a computer instruction thereon, and the computer instruction is used to cause a computer to execute the method of the first aspect of the present disclosure.

According to a fifth aspect of the disclosure, provided is a computer program product including a computer program, and the computer program implements, when executed by a processor, the method of the first aspect of the present disclosure.

According to the embodiments of the disclosure, the image classification accuracy can be improved.

It should be understood that the content described in this part is not intended to indicate critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a flowchart of an image classification method according to an embodiment of the present disclosure.

FIG. 2 is schematic diagram showing a process of feature fusion according to an embodiment of the present disclosure.

FIG. 3 is a schematic diagram showing a structure of an image classification model according to an embodiment of the present disclosure.

FIG. 4 is a general flow diagram of image classification according to an embodiment of the present disclosure.

FIG. 5 is a block diagram showing a structure of an image classification apparatus according to an embodiment of the present disclosure.

FIG. 6 is a schematic diagram showing a scene of image classification according to an embodiment of the present disclosure.

FIG. 7 is a block diagram of an electronic device for implementing an image classification method according to an embodiment of the present disclosure.

### DETAILED DESCRIPTION

Hereinafter, descriptions to exemplary embodiments of the present disclosure are made with reference to the accompanying drawings, include various details of embodiments of the present disclosure to facilitate understanding, and should be considered as merely exemplary. Therefore, those having ordinary skill in the art should realize, various changes and modifications may be made to embodiments described herein, without departing from the scope and spirit of the present disclosure. Likewise, for clarity and conciseness, descriptions of well-known functions and structures are omitted in the following descriptions.

The terms “first”, “second”, and “third”, etc., in the description embodiments and claims of the present disclosure and the above-described drawings are intended to distinguish between similar elements, and not necessarily to describe a particular sequential or chronological order. Furthermore, the terms “comprise”, “comprising”, “include”, and “including”, as well as any variations thereof, are intended to cover a non-exclusive inclusion; for example, a series of steps or elements is included. The methods, systems, products, or devices are not necessarily limited to the explicitly listed steps or elements, but may include other steps or elements not expressly listed or inherent to such processes, methods, products, or devices.

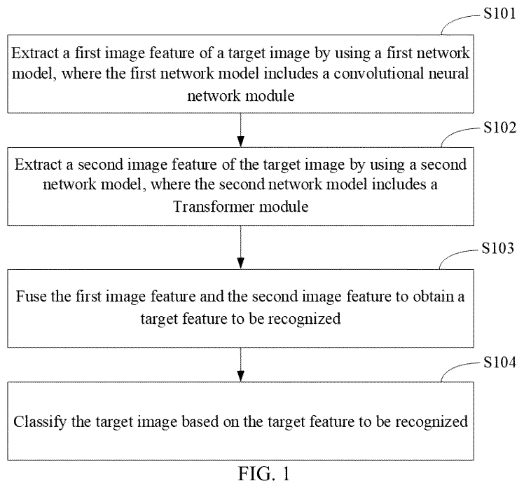

An embodiment of the present disclosure provides an image classification method, which may be applied to an image classification apparatus located in an electronic device including, but not limited to, a fixed and/or a mobile device/equipment/apparatus. For example, the fixed device/equipment/apparatus includes, but is not limited to, a server, which may be a cloud server or a general server. For example, the mobile device/equipment/apparatus includes, but is not limited to, a vehicle-mounted terminal, a navigation device, a mobile phone, a tablet computer, and the like. In some possible implementations, the image classification method may also be implemented by a processor invoking computer readable instructions stored in a memory. As shown in FIG. 1, the image classification method includes the followings.
S101: a first image feature of a target image is extracted by using a first network model, where the first network model includes a convolutional neural network module.
S102: a second image feature of the target image is extracted by using a second network model, where the second network model includes a Transformer module.
S103: the first image feature and the second image feature are fused to obtain a target feature to be recognized.
S104: the target image is classified based on the target feature to be recognized.

In an embodiment of the present disclosure, both the first network model and the second network model may be located in an image classification model. The image classification model is a model for classifying an image.

In an embodiment of the present disclosure, the first network model includes the convolutional neural network module. The present disclosure does not limit the number of convolution layers included in the convolutional neural network module. The first network model may be a convolutional neural network-based model.

Here, the convolutional neural network module may be a module composed of a convolution operation, a pooling operation, and an activation function, and responsible for extracting features of an image. After an image matrix is subjected to a convolution operation of a convolution kernel, another matrix, which is termed as feature map, may be obtained. Each convolution kernel may extract a specific feature, and different convolution kernels may extract different features.

In an embodiment of the present disclosure, the second network model includes the Transformer module. The present disclosure does not limit the number of network layers included in the Transformer module. The second network model may be a Deep Neural Network based on self-attention mechanism, such as a Transformer network.

Here, the Transformer module is a module composed of self-attention. The Transformer module has advantages of capturing global context information in an attention mode, and establishing a long-distance dependence on a target, so as to extract more powerful features. Accordingly, the Transformer module may well extract the global features of the image.

In an embodiment of the present disclosure, the target feature to be recognized may be a feature of a classifier input to the image classification model, such that the classifier recognizes a category of the target image based on the target feature to be recognized.

In an embodiment of the present disclosure, the category of the target image may be a category of an object included in the target image. Here, the object includes, but is not limited to, an animal, a plant, a vehicle, a building, a pedestrian, and the like.

In an embodiment of the present disclosure, the image categories may be divided according to the object to be recognized. For example, taking an animal as the object, the categories include, but are not limited to, cats, dogs, fish, birds, insects, and the like. For example, taking a vehicle as the object, the categories include, but are not limited to, private cars, buses, ambulances, taxis, school buses, and the like.

It should be understood that after the target feature to be recognized are obtained through S101 to S103, except for the image classification based on the target feature to be recognized, processing such as object detection, image segmentation, key point detection and object tracking may also be performed based on the target feature to be recognized.

The image classification method according to the present disclosure may be applied to face identification and intelligent video analysis in the security field, traffic scene recognition in the traffic field, content-based image retrieval and automatic album classification in the Internet field, image recognition in the medical field, and the like.

In the technical solution according to an embodiment of the present disclosure, the first image feature of the target image is extracted by the first network model; the second image feature of the target image is extracted by the second network model; the first image feature and the second image feature are fused to obtain the target feature to be recognized; the target image is classified based on the target feature to be recognized. The target feature to be recognized is obtained by fusing the first image feature extracted by the convolutional neural network module and the second image feature extracted by the Transformer module, so that the target feature to be recognized includes not only the global feature but also the local feature, thereby improving the accuracy of image classification.

In some embodiments, S103 includes: S103a, performing feature fusion on the first image feature with the second image feature in a first fusion mode to obtain a third image feature; S103b, performing feature fusion on the second image feature with the first image feature in a second fusion mode to obtain a fourth image feature; and S103c, performing feature fusion on the third image feature with the fourth image feature in a third fusion mode to obtain the target feature to be recognized.

Here, the first fusion mode refers to fusion of features at the same position in images by means of addition.

Here, the second fusion mode refers to fusion of features at a target position in the images by means of addition. Here, the target position may be a pre-determined position. For example, with the central point of the image as a center, an area within a certain radius range is set to be the target position. For another example, N positions are selected from the image, and the N positions are set to be the target position, where N is a positive integer. For yet another example, an area where the target object is located is determined from the image, and the area where the target object is located is set to be the target position.

Here, the third fusion mode refers to fusion of image features (e.g., the first image feature and the second image feature) from separate sources by means of superposition.

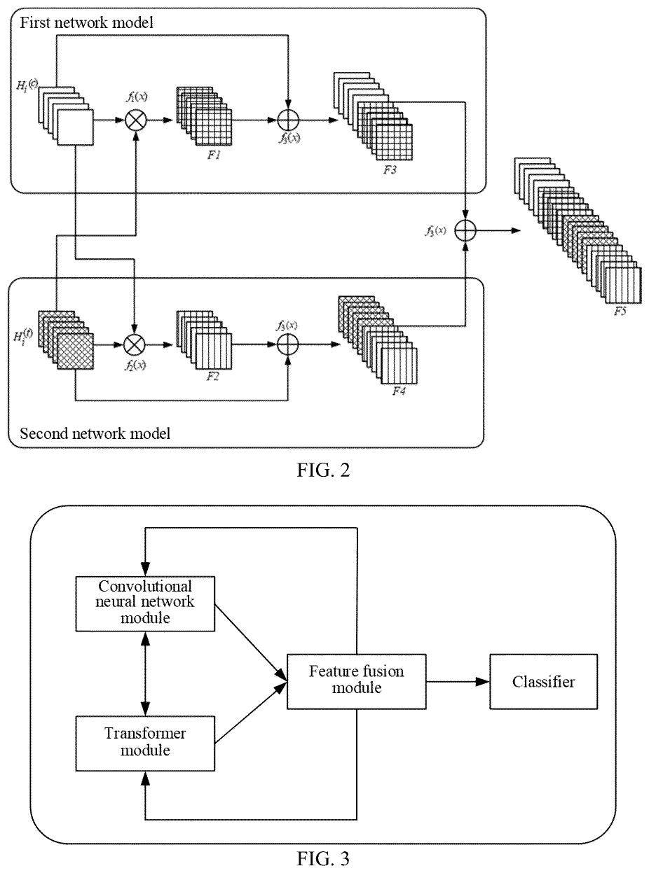

FIG. 2 shows a schematic flow diagram of feature fusion. As shown in FIG. 2, Hᵢ^{(c)} represents a first image feature extracted by a first network model, and Hᵢ^{(t)} represents a second image feature extracted by a second network model. f₁^{(x)} represents a first fusion mode, f₂^{(x)} represents a second fusion mode, and f₃^{(x)} represents a third fusion mode. F1 represents a third image feature obtained by a feature fusion of the first image feature with the second image feature in the first fusion mode. F2 represents a fourth image feature obtained by a feature fusion of the second image feature with the first image feature in the second fusion mode. F3 represents a first target feature obtained by a feature fusion of the first image feature Hᵢ^{(c)} with the third image feature F1 in the third fusion mode. F4 represents a second target feature obtained by a feature fusion of the second image feature Hᵢ^{(t)} with the fourth image feature F2 in the third fusion mode. F5 represents a target feature to be recognized obtained by the feature fusion of the first image feature with the second image feature in the third fusion mode.

For example, f₁(x)=Σᵢ₌₁^{c}Xᵢ*Kᵢ+Σᵢ₌₁^{c}Yᵢ*K_{i+c}, where in f₁(x), Xᵢ and Yᵢ each represents a channel of each input, Kᵢ represents the number of channels of Xᵢ, and K_{i+c} represents the number of channels of Yᵢ.

For example, f₂(x)=Σᵢ₌₁^{c}Yᵢ*K_{i+c}+Σᵢ₌₁^{c}Xᵢ*Kᵢ, where in f₂(x), Xᵢ and Yᵢ each represents a channel of each input, Kᵢ represents the number of channels of Xᵢ, and K_{i+c} represents the number of channels of Yᵢ.

For example, f₃(x)=Σᵢ₌₁^{c}(Xᵢ+Yᵢ)*Kᵢ=Σᵢ₌₁^{c}Xᵢ*Kᵢ+Σᵢ₊₁^{c}Yᵢ*Kᵢ, where in f₃(x), Xᵢ and Yᵢ each represents a channel of each input, Kᵢ represents the number of channels of Xᵢ, and Kᵢ represents the number of channels of Yᵢ.

It should be understood that the above f₁(x), f₂(x) and f₃(x) are only exemplary but not restrictive. Those skilled in the art may make various obvious changes and/or substitutions based on the above formula examples, and the obtained technical solutions still fall within the scope of embodiments of the present disclosure.

As can be seen from FIG. 2, the first fusion mode is the addition of values of the features. The second fusion mode is also the addition of values of the features. The third fusion mode is the concatenation of the features, which, instead of the addition of values of the features, increases the number of feature maps in a superposition manner. Accordingly, the features extracted from separate frameworks are fully utilized for fusion, and the feature expression capability of the image is improved.

As such, the determined target feature to be recognized includes not only the global feature but also the local feature, and the accuracy of image classification is improved.

In some embodiments, S103a includes: adding, by taking the first image feature as a reference, the second image feature and the first image feature at the same position of the target image to obtain the third image feature.

Here, the same position may be for any one position on the target image.

For example, if a first image feature at a first position (x1, y1) on an image extracted by a first network model is denoted as feature a1 and a second image feature at a first position (x1, y1) on the image extracted by a second network model is denoted as feature b1, the first network model may determine the sum of feature a1 and feature b1 as a third image feature at the first position (x1, y1). Similarly, the third image feature at any position (xi, yi) on the image is equal to the sum of the first image feature ai at the first position (xi, yi) on the image extracted by the first network model and the second image feature bi at the first position (xi, yi) on the image extracted by the second network model.

As shown in FIG. 2, F1 in FIG. 2 represents the third image feature obtained by feature fusion of the first image feature of the image and the second image feature of the image in the first fusion mode.

As such, the first image feature extracted by the first network model may be caused to be continuously fused with the second image feature extracted by the second network model, so that the extracted first image feature not only has the local feature extracted by the convolutional neural network but also fuses the global feature extracted by the Transformer, thereby improving the classification accuracy of the model.

In some embodiments, S103b includes: adding, by taking the second image feature as a reference, the second image feature and the first image feature at a target position of the target image to obtain the fourth image feature.

For example, if a second image feature at a target position (x2′, y2′) on an image extracted by a second network model is denoted as feature b2′ and a first image feature at the target position (x2′, y2′) on the image extracted by a first network model is denoted as feature a2′, the second network model may determine the sum of feature b2′ and feature a2′ as a fourth image feature at the target position (x2′, y2′). Similarly, the fourth image feature at any position (xi′, yi′) on the image is equal to the sum of the second image feature bi′ at the first position (xi′, yi′) on the image extracted by the second network model and the first image feature ai′ at the first position (xi, yi) on the image extracted by the first network model.

As shown in FIG. 2, F2 in FIG. 2 represents the fourth image feature obtained by feature fusion of the first image feature of the image and the second image feature of the image in the second fusion mode.

As such, the second image feature extracted by the second network model may be caused to be continuously fused with the first image feature extracted by the first network model, so that the extracted second image feature not only has the global feature extracted by the Transformer but also fuse the local feature extracted by the convolutional neural network, thereby improving the classification accuracy of the model.

In some embodiments, S103c includes: performing feature superposition on the third image feature and the first image feature to obtain a first target feature; performing feature superposition on the fourth image feature and the second image feature to obtain a second target feature; and performing feature superposition on the first target feature and the second target feature to obtain the target feature to be recognized.

Here, the first target feature may be understood as a first image feature extracted from the target image, which is lastly output by the first network model.

For example, if a first network model includes two convolution layers, a first convolution layer extracts a first image feature (denoted as feature a1) at a first position (x1, y1) on an image and a second network model extracts a second image feature (denoted as feature b1) at the first position (x1, y1) on the image, the first network model will determine the sum of feature a1 and feature b1 as the third image feature at the first position (x1, y1). Then the third image feature is input into the second convolution layer and a first image feature (denoted as feature a2) is output, and then a first target feature a may be a superposition of feature a2 and (feature a1+feature b1). In the first target feature a, feature a2 may be located in front of (feature a1+feature b1), or feature a2 may be located behind (feature a1+feature b1). The present disclosure does not limit the ordering of features.

Here, the second target feature may be understood as a second image feature extracted from the target image, which is lastly output by the second network model.

For example, if a second network model includes two Transformer modules, a first Transformer module extracts a second image feature (denoted as feature b1) at a first position (x1, y1) on an image and a first network model extracts a first image feature (denoted as feature a1) at the first position (x1, y1) on the image, the second network model will determine the sum of feature b1 and feature a1 as a fourth image feature at the first position (x1, y1). Then the fourth image feature is input into the second Transformer module and a second image feature (denoted as feature b2) is output, and then a second target feature b may be a superposition of feature b2 and (feature b1+feature a1). In the second target feature b, feature b2 may be located in front of (feature b1+feature a1), or feature b2 may be located behind (feature b1+feature a1). The present disclosure does not limit the ordering of features.

As such, the determined target feature to be recognized not only has the global feature extracted by the Transformer but also fuses the local feature extracted by the convolutional neural network, thereby improving the classification accuracy of the model.

In some embodiments, the performing of the feature superposition on the first target feature and the second target feature to obtain the target feature to be recognized includes: performing feature fusion on a first target feature determined by an m-th convolution layer of the first network model and a second target feature determined by an n-th network layer of the second network model to obtain a k-th target feature, where m, n and k all are positive integers greater than or equal to 1; inputting the k-th target feature into an (m+1)-th convolution layer of the first network model and an (n+1)-th network layer of the second network model, respectively, to obtain a first target feature output by the (m+1)-th convolution layer of the first network model and a second target feature output by the (n+1)-th network layer of the second network model; performing feature fusion on the first target feature and the second target feature to obtain a (k+1)-th target feature; and determining the (k+1)-th target feature as the target feature to be recognized.

Here, values of m, n, and k may be set according to requirements such as a speed requirement or an accuracy requirement.

As such, it is possible to improve the accuracy of the target feature to be recognized, thereby improving the classification accuracy of the model.

In some embodiments, the image classification method may further include: obtaining indication information, where the indication information is used for indicating a detection category of the target image; determining a first running layer number of the first network model and a second running layer number of the second network model based on the indication information; and determining a value of m, a value of n, and a value of k based on the first running layer number and the second running layer number.

Here, the image classification model includes a first network model and a second network model. The first network model includes P detection branches to support detection of P categories, and different detection branches correspond to different running layer number. The second network model includes Q detection branches to support detection of Q categories, and different detection branches correspond to different running layer number. Illustratively, the detection branch 1 is used to support detection of category 1, the running layer number of the first network model is required to be m1, the running layer number of the second network model is required to be n1, and the number of times of the target feature to be obtained is k1; the detection branch 2 is used to support detection of category 2, the running layer number of the first network model is required to be m2, the running layer number of the second network model is required to be n2, and the number of times of the target feature to be obtained is k2.

Here, the indication information may be indication information for an image classification model input by a user through a user interface. In practical application, an electronic device presents a plurality of detection categories supported by the image classification model to a user through the user interface, so that the user can specify one or more detection categories from the plurality of detection categories. Further, the indication information may further include resource indication information, which is used to indicate information of resources required for training or detecting the image classification model. The resource indication information includes indication information of at least one of the following resources: a Central Processing Unit (CPU), a memory, and a Graphics Processing Unit (GPU). It may be understood that in some embodiments, in a case that the indication information does not carry the resource indication information, the electronic device may automatically determine the resource indication information for the image classification model.

In an embodiment of the present disclosure, the image classification model may be a model obtained by training according to a preset model. For example, the preset model may be a Region Convolutional neural Network (RCNN) model. For another example, the preset model may be a Fully Convolutional Network (FCN) model. For yet another example, the preset model may be a model based on the YOLOV3 (You Only Look Once Version 3) algorithm. The above is only an exemplary illustration and is not intended as a limitation of all possible types of the preset models, and thus it is not exhaustive here. It should be understood that, how to train to obtain the image classification model is not limited in embodiments of the present disclosure.

As such, the detection and output of the image classification model may be controlled by selecting the detection category, thereby realizing the detection diversity supported by the image classification model.

In some embodiments, the performing of the feature fusion on the first image feature and the second image feature in the first fusion mode to obtain the third image feature includes: inputting a first image feature output by a j-th convolution layer of the first network model and a second image feature output by an i-th network layer of the second network model into a (j+1)-th convolution layer of the first network model to obtain a first image feature output by the (j+1)-th convolution layer of the first network model, where i and j both are positive integers greater than or equal to 1; and determining the third image feature according to the first image feature output by the (j+1)-th convolution layer of the first network model.

In some embodiments, the first image feature output by the (j+1)-th convolution layer of the first network model is used as the third image feature.

In some embodiments, the third image feature is obtained by only performing feature fusion on the first image feature output by the (j+1)-th convolution layer of the first network model and the second image feature output by the i-th network layer of the second network model in the first fusion mode.

In some embodiments, the third image feature may be obtained by performing feature fusion on the second image feature output by the i-th network layer of the second network model and the first image feature output by each convolution layer of the first network model, and finally performing feature fusion on the first image feature output by the (j+1)-th convolution layer of the first network model and the second image feature output by the i-th network layer of the second network model in the first fusion mode.

As such, the first image feature extracted by the first network model may be caused to be continuously fused with the second image feature extracted by the second network model, so that the extracted first image feature not only has the local feature extracted by the convolutional neural network but also fuses the global feature extracted by the Transformer, thereby improving the classification accuracy of the model.

In some embodiments, the performing of the feature fusion on the second image feature and the first image feature in the second fusion mode to obtain the fourth image feature includes: inputting a second image feature output by a q-th network layer of the second network model and a first image feature output by a p-th convolution layer of the first network model into a (q+1)-th network layer of the second network model to obtain a second image feature output by the (q+1)-th network layer of the second network model, where p and q both are positive integers greater than or equal to 1; and determining the fourth image feature according to the second image feature output by the (q+1)-th network layer of the second network model.

In some embodiments, the second image feature output by the (q+1)-th network layer of the second network model is used as the fourth image feature.

In some embodiments, the fourth image feature is obtained by only performing feature fusion on the second image feature output by the (q+1)-th network layer of the second network model and the first image feature output by the p-th convolution layer of the first network model in the second fusion mode.

In some embodiments, the fourth image feature is obtained by performing feature fusion on the first image feature output by the p-th convolution layer of the first network model and the second image feature output by each network layer of the second network model, and finally performing the feature fusion on the second image feature output by the (q+1)-th network layer of the second network model and the first image feature output by the p-th convolution layer of the first network model in the second fusion mode.

As such, the second image feature extracted by the second network model may be caused to be continuously fused with the first image feature extracted by the first network model, so that the extracted second image feature not only has the local feature extracted by the convolutional neural network but also fuses the global feature extracted by the Transformer, thereby improving the classification accuracy of the model.

FIG. 3 is a schematic diagram showing a structure of an image classification model. As shown in FIG. 3, after an image is input into a network structure, a convolutional neural network module and a Transformer module extract features in the image, respectively, and then the features are input into a feature fusion module for feature fusion. The fused features are continuously input into the convolutional neural network module and the Transformer module for feature extraction of the next layer, until target features obtained after fusion are input into a linear classifier (SoftMax). The linear classifier classifies the image. In the whole process, the features obtained by the convolutional neural network module and the features obtained by the Transformer module are continuously fused, so that the whole network not only has local features extracted by the convolutional neural network module but also fuses global features extracted by the Transformer module, thereby improving the classification accuracy of the model.

It should be understood that the structural diagram shown in FIG. 3 is only illustrative and not restrictive. Those skilled in the art can make various obvious changes and/or substitutions based on the example of FIG. 3, and the resulting technical solutions still fall within the scope of embodiments of the present disclosure.

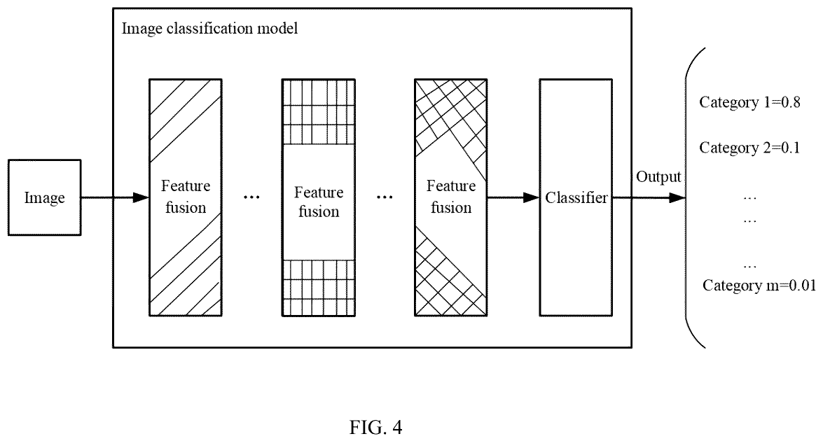

FIG. 4 is a general flow diagram of image classification. As shown in FIG. 4, after an image is input into an image classification model, a convolutional neural network module and a Transformer module in the image classification model extract features in the image, respectively, and then the features are input into a feature fusion module for feature fusion. The fused features are continuously input into the convolutional neural network module and the Transformer module for feature extraction of the next layer, until target features obtained after final fusion are input into a classifier. The classifier classifies the image and outputs predicted values of respective categories. In the whole process, the features obtained by the convolutional neural network module and the features obtained by the Transformer module are continuously fused, so that the whole network not only has local features extracted by the convolutional neural network module but also fuses global features extracted by the Transformer module, thereby improving the classification accuracy of the model.

It should be understood that the general flow diagram shown in FIG. 4 is only illustrative and not restrictive. Those skilled in the art can make various obvious changes and/or substitutions based on the example of FIG. 4, and the resulting technical solutions still fall within the scope of the embodiments of the present disclosure.

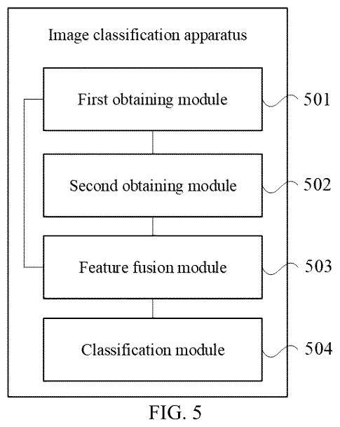

An embodiment of the present disclosure provides an image classification apparatus. As shown in FIG. 5, the image classification apparatus includes: a first obtaining module 501, configured to extract a first image feature of a target image by using a first network model, where the first network model includes a convolutional neural network module; a second obtaining module 502, configured to extract a second image feature of the target image by using a second network model, where the second network model includes a Transformer module; a feature fusion module 503, configured to fuse the first image feature and the second image feature to obtain a target feature to be recognized; and a classification module 504, configured to classify the target image based on the target feature to be recognized.

In some embodiments, the feature fusion module 503 includes: a first fusion sub-module, configured to perform feature fusion on the first image feature with the second image feature in a first fusion mode to obtain a third image feature; a second fusion sub-module, configured to perform feature fusion on the second image feature with the first image feature in a second fusion mode to obtain a fourth image feature; and a third fusion sub-module, configured to perform feature fusion on the third image feature with the fourth image feature in a third fusion mode to obtain the target feature to be recognized.

In some embodiments, the first fusion sub-module is configured to add, by taking the first image feature as a reference, the second image feature and the first image feature at the same position of the target image to obtain the third image feature.

In some embodiments, the second fusion sub-module is configured to add, by taking the second image feature as a reference, the second image feature and the first image feature at a target position of the target image to obtain the fourth image feature.

In some embodiments, the third fusion sub-module is configured to perform feature superposition on the third image feature and the first image feature to obtain a first target feature; perform feature superposition on the fourth image feature and the second image feature to obtain a second target feature; and perform feature superposition on the first target feature and the second target feature to obtain the target feature to be recognized.

In some embodiments, the first fusion sub-module is further configured to input a first image feature output by a j-th convolution layer of the first network model and a second image feature output by an i-th network layer of the second network model into a (j+1)-th convolution layer of the first network model to obtain a first image feature output by the (j+1)-th convolution layer of the first network model, where i and j both are positive integers greater than or equal to 1; and determine the third image feature according to the first image feature.

In some embodiments, the second fusion sub-module is further configured to input a second image feature output by a q-th network layer of the second network model and a first image feature output by a p-th convolution layer of the first network model into a (q+1)-th network layer of the second network model to obtain a second image feature output by the (q+1)-th network layer of the second network model, where p and q both are positive integers greater than or equal to 1; and determine the fourth image feature according to the second image feature.

In some embodiments, the third fusion sub-module is further configured to perform feature fusion on a first target feature determined by an m-th convolution layer of the first network model and a second target feature determined by an n-th network layer of the second network model to obtain a k-th target feature, where m, n and k all are positive integers greater than or equal to 1; input the k-th target feature into an (m+1)-th convolution layer of the first network model and an (n+1)-th network layer of the second network model, respectively, to obtain a first target feature output by the (m+1)-th convolution layer of the first network model and a second target feature output by the (n+1)-th network layer of the second network model; perform feature fusion on the first target feature and the second target feature to obtain a (k+1)-th target feature; and determine the target feature to be recognized according to the (k+1)-th target feature.

In some embodiments, the image classification apparatus further includes: a third obtaining module configured to obtain indication information, where the indication information is used for indicating a detection category of the target image; a first determining module, configured to determine a first running layer number of the first network model and a second running layer number of the second network model based on the indication information; and a second determining module configured to determine a value of m, a value of n, and a value of k based on the first running layer number and the second running layer number.

It should be understood by those skilled in the art that the functions of the processing modules in the image classification apparatus according to an embodiment of the present disclosure may be understood with reference to the foregoing description of the image classification method, and each processing module in the image classification apparatus according to the embodiment of the present disclosure may be implemented by an analog circuit that implements the functions described in the embodiments of the present disclosure, or may be implemented by running software that implements the functions described in embodiments of the present disclosure on an electronic device.

The image classification apparatus according to embodiments of the disclosure can improve the accuracy of image classification.

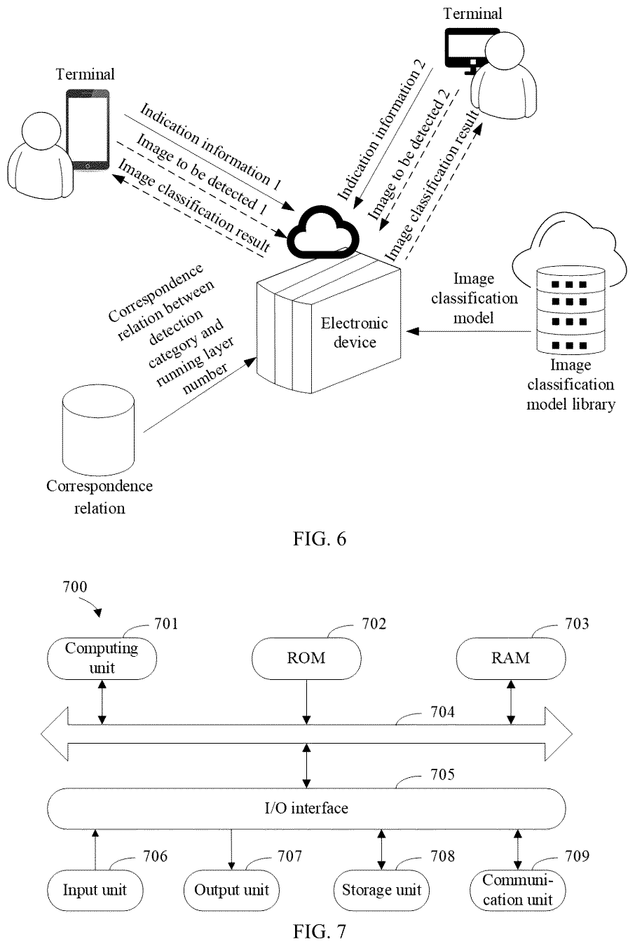

FIG. 6 is a schematic diagram showing a scene of image classification. As can be seen from FIG. 6, an electronic device such as a cloud server receives an image to be detected imported from a respective terminal; and detects the received image to be detected by using the image classification model, and outputs an image classification result as for the image to be detected. The electronic device also receives indication information sent from a respective terminal, where the indication information includes a detection category; and determines the running layer numbers of the first and second network models included in the image classification model based on the detection category indicated by the indication information.

The numbers of the terminals and the electronic devices are not limited in the present disclosure. In practical applications, there may be a plurality of terminals and a plurality of electronic devices.

It should be understood that the scene diagram shown in FIG. 6 is only illustrative and not restrictive. Those skilled in the art can make various obvious changes and/or substitutions based on the example of FIG. 6, and the resulting technical solutions still fall within the scope of embodiments of the present disclosure.

In the technical solution of the present disclosure, the acquisition, storage and application of user's personal information involved are all in compliance with the provisions of relevant laws and regulations, and do not violate public order and good customs.

According to embodiments of the present disclosure, the present disclosure also provides an electronic device, a readable storage medium and a computer program product.

FIG. 7 shows a schematic block diagram of an exemplary electronic device 700 that may be used to implement embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as personal digital processing, a cellular phone, a smart phone, a wearable device and other similar computing devices. The components shown herein, their connections and relationships, as well as their functions are merely examples, and are not intended to limit implementations of the present disclosure described and/or required herein.

As shown in FIG. 7, the electronic device 700 includes a computing unit 701 that may perform various appropriate actions and processes according to a computer program stored in a Read-Only Memory (ROM) 702 or a computer program loaded from a storage unit 708 into a Random Access Memory (RAM) 703. Various programs and data required for an operation of the electronic device 700 may also be stored in the RAM 703. The computing unit 701, ROM 702 and RAM 703 are connected to each other through a bus 704. The input/output (I/O) interface 705 is also connected to the bus 704.

A plurality of components in the electronic device 700 are connected to the I/O interface 705, and include an input unit 706 such as a keyboard, a mouse, or the like, an output unit 707 such as various types of displays, speakers, or the like, the storage unit 708 such as a magnetic disk, an optical disk, or the like, and a communication unit 709 such as a network card, a modem, a wireless communication transceiver, or the like. The communication unit 709 allows the device 700 to exchange information/data with other devices through a computer network such as the Internet and/or various telecommunication networks.

The computing unit 701 may be various general-purpose and/or special-purpose processing components with processing and computing capabilities. Some examples of the computing unit 701 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 701 performs various methods and processing described above, such as the above image classification method. For example, in some embodiments, the above image classification method may be implemented as a computer software program that is tangibly contained in a computer-readable medium, such as the storage unit 708. In some embodiments, a part or all of the computer program may be loaded and/or installed on the device 700 via ROM 702 and/or the communication unit 709. When the computer program is loaded into RAM 703 and executed by the computing unit 701, one or more steps of the image classification method described above may be performed. Alternatively, in other embodiments, the computing unit 701 may be configured to perform the above image classification method by any other suitable means (e.g., by means of firmware).

Various implements of the system and technologies described above herein may be implemented in a digital electronic circuit system, an integrated circuit system, a Field Programmable Gate Array (FPGA), an Application Specific Integrated Circuit (ASIC), Application Specific Standard Parts (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system including a back-end component (e.g., as a data server), or in a computing system including a middleware (e.g., as an application server), or in a computing system including a front-end component (e.g., as a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and the server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using various forms of the flows described above. For example, the steps recorded in the present disclosure can be performed in parallel, in sequence, or in different orders, as long as a desired result of the technical solution disclosed in the present disclosure can be realized, which is not limited herein.

The foregoing specific implementations do not constitute a limitation to the protection scope of the present disclosure. Those having ordinary skill in the art should understand that, various modifications, combinations, sub-combinations and substitutions may be made according to a design requirement and other factors. Any modification, equivalent replacement, improvement or the like made within the spirit and principle of the present disclosure should be included in the protection scope of the present disclosure.

What is claimed is:

1. An image classification method, comprising:
extracting a first image feature of a target image by using a first network model, wherein the first network model comprises a convolutional neural network module;
extracting a second image feature of the target image by using a second network model, wherein the second network model comprises a deep self-attention transformer network (Transformer) module;
fusing the first image feature and the second image feature to obtain a target feature to be recognized; and
classifying the target image based on the target feature to be recognized.

2. The method of claim 1, wherein fusing the first image feature and the second image feature to obtain the target feature to be recognized, comprises:
performing feature fusion on the first image feature with the second image feature in a first fusion mode to obtain a third image feature;
performing feature fusion on the second image feature with the first image feature in a second fusion mode to obtain a fourth image feature; and
performing feature fusion on the third image feature with the fourth image feature in a third fusion mode to obtain the target feature to be recognized.

3. The method of claim 2, wherein performing the feature fusion on the first image feature with the second image feature in the first fusion mode to obtain the third image feature, comprises:
adding, by taking the first image feature as a reference, the second image feature and the first image feature at a same position of the target image to obtain the third image feature.

4. The method of claim 2, wherein performing the feature fusion on the second image feature with the first image feature in the second fusion mode to obtain the fourth image feature, comprises:
adding, by taking the second image feature as a reference, the first image feature and the second image feature at a target position of the target image to obtain the fourth image feature.

5. The method of claim 2, wherein performing the feature fusion on the third image feature with the fourth image feature in the third fusion mode to obtain the target feature to be recognized, comprises:
performing feature superposition on the third image feature and the first image feature to obtain a first target feature;
performing feature superposition on the fourth image feature and the second image feature to obtain a second target feature; and
performing feature superposition on the first target feature and the second target feature to obtain the target feature to be recognized.

6. The method of claim 5, wherein performing the feature superposition on the first target feature and the second target feature to obtain the target feature to be recognized, comprises:
performing the feature fusion on a first target feature determined by an m-th convolution layer of the first network model and a second target feature determined by an n-th network layer of the second network model to obtain a k-th target feature, wherein m, n and k all are positive integers greater than or equal to 1;
inputting the k-th target feature into an (m+1)-th convolution layer of the first network model and an (n+1)-th network layer of the second network model, respectively, to obtain a first target feature output by the (m+1)-th convolution layer of the first network model and a second target feature output by the (n+1)-th network layer of the second network model;
performing the feature fusion on the first target feature and the second target feature to obtain a (k+1)-th target feature; and
determining the target feature to be recognized according to the (k+1)-th target feature.

7. The method of claim 6, further comprising:
obtaining indication information, wherein the indication information is used for indicating a detection category of the target image;
determining a first running layer number of the first network model and a second running layer number of the second network model based on the indication information; and
determining a value of m, a value of n, and a value of k based on the first running layer number and the second running layer number.

8. The method of claim 2, wherein performing the feature fusion on the first image feature with the second image feature in the first fusion mode to obtain the third image feature, comprises:
inputting a first image feature output by a j-th convolution layer of the first network model and a second image feature output by an i-th network layer of the second network model into a (j+1)-th convolution layer of the first network model to obtain a first image feature output by the (j+1)-th convolution layer of the first network model, wherein i and j both are positive integers greater than or equal to 1; and
determining the third image feature according to the first image feature.

9. The method of claim 2, wherein performing the feature fusion on the second image feature with the first image feature in the second fusion mode to obtain the fourth image feature, comprises:
inputting a second image feature output by a q-th network layer of the second network model and a first image feature output by a p-th convolution layer of the first network model into a (q+1)-th network layer of the second network model to obtain a second image feature output by the (q+1)-th network layer of the second network model, wherein p and q both are positive integers greater than or equal to 1; and
determining the fourth image feature according to the second image feature.

10. An electronic device, comprising:
at least one processor; and
a memory connected in communication with the at least one processor;
wherein the memory stores an instruction executable by the at least one processor, and the instruction, when executed by the at least one processor, enables the at least one processor to execute operations, comprising:
extracting a first image feature of a target image by using a first network model, wherein the first network model comprises a convolutional neural network module;
extracting a second image feature of the target image by using a second network model, wherein the second network model comprises a deep self-attention transformer network (Transformer) module;
fusing the first image feature and the second image feature to obtain a target feature to be recognized; and
classifying the target image based on the target feature to be recognized.

11. The electronic device of claim 10, wherein fusing the first image feature and the second image feature to obtain the target feature to be recognized, comprises:
performing feature fusion on the first image feature with the second image feature in a first fusion mode to obtain a third image feature;
performing feature fusion on the second image feature with the first image feature in a second fusion mode to obtain a fourth image feature; and
performing feature fusion on the third image feature with the fourth image feature in a third fusion mode to obtain the target feature to be recognized.

12. The electronic device of claim 11, wherein performing the feature fusion on the first image feature with the second image feature in the first fusion mode to obtain the third image feature, comprises:
adding, by taking the first image feature as a reference, the second image feature and the first image feature at a same position of the target image to obtain the third image feature.

13. The electronic device of claim 11, wherein performing the feature fusion on the second image feature with the first image feature in the second fusion mode to obtain the fourth image feature, comprises:
adding, by taking the second image feature as a reference, the first image feature and the second image feature at a target position of the target image to obtain the fourth image feature.

14. The electronic device of claim 11, wherein performing the feature fusion on the third image feature with the fourth image feature in the third fusion mode to obtain the target feature to be recognized, comprises:
performing feature superposition on the third image feature and the first image feature to obtain a first target feature;
performing feature superposition on the fourth image feature and the second image feature to obtain a second target feature; and
performing feature superposition on the first target feature and the second target feature to obtain the target feature to be recognized.

15. The electronic device of claim 14, wherein performing the feature superposition on the first target feature and the second target feature to obtain the target feature to be recognized, comprises:
performing the feature fusion on a first target feature determined by an m-th convolution layer of the first network model and a second target feature determined by an n-th network layer of the second network model to obtain a k-th target feature, wherein m, n and k all are positive integers greater than or equal to 1;
inputting the k-th target feature into an (m+1)-th convolution layer of the first network model and an (n+1)-th network layer of the second network model, respectively, to obtain a first target feature output by the (m+1)-th convolution layer of the first network model and a second target feature output by the (n+1)-th network layer of the second network model;
performing the feature fusion on the first target feature and the second target feature to obtain a (k+1)-th target feature; and
determining the target feature to be recognized according to the (k+1)-th target feature.

16. A non-transitory computer-readable storage medium storing a computer instruction thereon, wherein the computer instruction is used to cause a computer to execute operations, comprising:
extracting a first image feature of a target image by using a first network model, wherein the first network model comprises a convolutional neural network module;
extracting a second image feature of the target image by using a second network model, wherein the second network model comprises a deep self-attention transformer network (Transformer) module;
fusing the first image feature and the second image feature to obtain a target feature to be recognized; and
classifying the target image based on the target feature to be recognized.

17. The storage medium of claim 16, wherein fusing the first image feature and the second image feature to obtain the target feature to be recognized, comprises:
performing feature fusion on the first image feature with the second image feature in a first fusion mode to obtain a third image feature;
performing feature fusion on the second image feature with the first image feature in a second fusion mode to obtain a fourth image feature; and
performing feature fusion on the third image feature with the fourth image feature in a third fusion mode to obtain the target feature to be recognized.

18. The storage medium of claim 17, wherein performing the feature fusion on the first image feature with the second image feature in the first fusion mode to obtain the third image feature, comprises:
adding, by taking the first image feature as a reference, the second image feature and the first image feature at a same position of the target image to obtain the third image feature.

19. The storage medium of claim 17, wherein performing the feature fusion on the second image feature with the first image feature in the second fusion mode to obtain the fourth image feature, comprises:
adding, by taking the second image feature as a reference, the first image feature and the second image feature at a target position of the target image to obtain the fourth image feature.

20. The storage medium of claim 17, wherein performing the feature fusion on the third image feature with the fourth image feature in the third fusion mode to obtain the target feature to be recognized, comprises:
performing feature superposition on the third image feature and the first image feature to obtain a first target feature;
performing feature superposition on the fourth image feature and the second image feature to obtain a second target feature; and
performing feature superposition on the first target feature and the second target feature to obtain the target feature to be recognized.
